(19) United States
(12) Patent Application Publication
(10) Pub. No.: US 2026/0009605 A1
(43) Pub. Date: Jan. 8, 2026

(54) VEHICLE HEAT EXCHANGER

(71) Applicant: JAPAN CLIMATE SYSTEMS CORPORATION, Hiroshima (JP)

(72) Inventors: Kazutoshi HYAKUDA, Hiroshima (JP); Masayoshi KURIHARA, Hiroshima (JP)

(73) Assignee: JAPAN CLIMATE SYSTEMS CORPORATION, Hiroshima (JP)

(21) Appl. No.: 19/250,054

(22) Filed: Jun. 25, 2025

Related U.S. Application Data
(63) Continuation of application No. PCT/JP2023/033735, filed on Sep. 15, 2023.

(30) Foreign Application Priority Data
Jan. 23, 2023 (JP) 2023-008124

(51) Int. Cl. F28F 9/26; B60K 1/00; F28F 3/12

(52) U.S. Cl. CPC F28F 9/26; B60K 1/00; F28F 3/12; B60K 2001/005; F28F 2275/04

(57) ABSTRACT

A first flow-path-forming plate made of a metal and in contact with the outer surface of a battery, and a second flow-path-forming plate made of a metal and joined to an opposite side to the battery are brazed to each other. A flow path that allows a liquid heat exchange medium to flow is provided between the first flow-path-forming plate and the second flow-path-forming plate. The first flow-path-forming plate has a through hole for insertion of a base end portion of a pipe member for supplying and discharging the heat exchange medium. A brazing portion is provided at a portion of the base end portion of the pipe member located inside the flow path, the brazing portion being brazed to the inner surface of the first flow-path-forming plate.

### CROSS-REFERENCE TO RELATED APPLICATIONS

This is a continuation of International Application No. PCT/JP2023/033735 filed on Sep. 15, 2023, which claims priority to Japanese Patent Application No. 2023-008124 filed on Jan. 23, 2023. The entire disclosures of these applications are incorporated by reference herein.

### BACKGROUND

The present disclosure relates to a vehicle heat exchanger for adjusting the temperature of a battery mounted on a vehicle.

An electric vehicle, for example, is equipped with a high-voltage battery for supplying electric power to a traction motor, separately from an auxiliary battery. The high-voltage battery is difficult to supply electric power, or its life is shortened, if it is in a high-temperature state due to heat generated during charging and discharging; therefore, the high-voltage battery is cooled by a heat exchanger. In addition, the charge-discharge performance of the high-voltage battery is extremely lowered if it is in an extremely low-temperature state; therefore, the high-voltage battery is heated by the heat exchanger.

For example, Japanese Unexamined Patent Publication No. 2021-125346 discloses a cooling mechanism that cools a battery module using a liquid medium. The cooling mechanism has a refrigerant flow path formed by a partition wall portion and a cover plate, and the liquid medium and the battery module exchange heat while the liquid medium is flowing through the refrigerant flow path, thereby cooling the battery module.

### SUMMARY

A heat exchanger that exchanges heat between a battery and a heat exchange medium is needed to cool or heat the battery. Since the heat exchanger needs to have a flow path through which the heat exchange medium can flow, the heat exchanger needs to be configured by combining multiple members, as in Japanese Unexamined Patent Publication No. 2021-125346, and further needs to include a pipe member for supplying and discharging the heat exchange medium into and from the heat exchanger.

Here, it is conceivable to braze two metal plates, e.g., a first plate and a second plate, to each other to form a heat exchanger having a flow path therein. A brazing surface needs a sacrificial layer; therefore, it is necessary to provide a sacrificial layer on each of a surface of the first plate toward the second plate (inner surface of the first plate) and a surface of the second plate toward the first plate (inner surface of the second plate).

In providing a pipe member in this configuration, if the pipe member is inserted in a through hole formed in the first plate and brazed to an outer surface of the first plate, it becomes possible to braze the pipe member to the first plate simultaneously with the brazing of the first and second plates, thus improving the manufacturing efficiency of the heat exchanger.

However, in order to braze the pipe member to the outer surface of the first plate, a sacrificial layer is necessary on the outer surface of the first plate as well. In other words, since the first plate requires sacrificial layers on both of its surfaces, there is a problem of increased material cost.

It is therefore an object of the present disclosure to reduce a material cost for a heat exchanger formed by brazing a plurality of plates and further brazing a pipe member to the plates.

In order to achieve the above object, an aspect of the present disclosure can be premised on a vehicle heat exchanger for a temperature adjustment of a battery that supplies electric power to a traction motor mounted on a vehicle. A first flow-path-forming plate made of a metal and a second flow-path-forming plate made of a metal are brazed to each other, the first flow-path-forming plate being in contact with an outer surface of the battery, the second flow-path-forming plate being arranged on an opposite side of the first flow-path-forming plate to the battery. A flow path that allows a liquid heat exchange medium to flow is provided between the first flow-path-forming plate and the second flow-path-forming plate. The first flow-path-forming plate has a through hole for insertion of a base end portion of a pipe member for supplying and discharging the heat exchange medium. A brazing portion is provided at a portion of the base end portion of the pipe member located inside the flow path, the brazing portion being brazed to an inner surface of the first flow-path-forming plate.

According to this configuration, to braze the first flow-path-forming plate and the second flow-path-forming plate, a sacrificial layer is provided on each of a surface of the first flow-path-forming plate (inner surface of the first flow-path-forming plate) facing the second flow-path-forming plate and a surface of the second flow-path-forming plate (inner surface of the second flow-path-forming plate) facing the first flow-path-forming plate, which enables brazing between the first flow-path-forming plate and the second flow-path-forming plate. The plate having the sacrificial layer can be made of a clad material, for example.

In brazing the pipe member to the first flow-path-forming plate, the brazing portion of the pipe member is located inside the flow path and is brazed to the inner surface of the first flow-path-forming plate; therefore, it is not necessary to provide a sacrificial layer on the outer surface of the first flow-path-forming plate. Thus, it is only necessary to prepare the first flow-path-forming plate and the second flow-path-forming plate each having a sacrificial layer on one surface, and a material cost is lower than that of a plate having sacrificial layers on both surfaces.

The first flow-path-forming plate may have a flat portion at a portion corresponding to the flow path. In this case, the through hole is formed so as to penetrate the flat portion, and the brazing portion can be brazed to the inner surface of the flat portion. The flat portion has a simpler shape than a curved portion, which enables improved forming accuracy. Brazing the brazing portion to this flat portion results in favorable brazing characteristics.

The first flow-path-forming plate and the second flow-path-forming plate may be formed of plates each having a sacrificial layer only on a surface to be brazed. Accordingly, the material cost for the first flow-path-forming plate and the second flow-path-forming plate can be reliably reduced.

The first flow-path-forming plate may be arranged so as to be in contact with a bottom surface of the battery, and may have a long shape in a predetermined direction along the bottom surface. In this case, the second flow-path-forming plate may be arranged under the first flow-path-forming plate, and extend in the predetermined direction. It is thus possible to adjust the temperature in a wide area of the bottom surface of the battery.

The pipe member may include a first pipe member to supply the heat exchange medium to the flow path and a second pipe member to discharge the heat exchange medium from the flow path, the first pipe member being provided on one side in a longitudinal direction of the first flow-path-forming plate, the second pipe member being provided on the other side in the longitudinal direction of the first flow-path-forming plate. In this case, a first through hole for insertion of a base end portion of the first pipe member can be formed on the one side in the longitudinal direction of the first flow-path-forming plate, and a second through hole for insertion of a base end portion of the second pipe member can be formed on the other side in the longitudinal direction of the first flow-path-forming plate. Further, a first brazing portion can be provided at a portion of the base end portion of the first pipe member located inside the flow path, the first brazing portion being brazed to the inner surface of the first flow-path-forming plate, and a second brazing portion can be provided at a portion of the base end portion of the second pipe member located inside the flow path, the second brazing portion being brazed to the inner surface of the first flow-path-forming plate. Accordingly, multiple pipe members for supplying and discharging the heat exchange medium can be brazed simultaneously, making it possible to reduce the number of manufacturing steps.

The brazing portion may be formed of a projection projecting radially outward from an outer surface of the pipe member and extending in a circumferential direction. The projection closes a portion between the outer surface of the pipe member and the inner surface of the through hole, thereby ensuring high sealability.

The first flow-path-forming plate may have a temporary fixing portion to fix temporarily the pipe member to the first flow-path-forming plate. According to this configuration, it is possible to prevent the pipe member from dropping or becoming misaligned during brazing of the pipe member to the first flow-path-forming plate; therefore, the pipe member can be brazed to a predetermined position of the first flow-path-forming plate with accuracy.

The temporary fixing portion may be formed of a swaging portion to be swaged and fixed to the pipe member. Accordingly, the pipe member can be fixed temporarily to the first flow-path-forming plate firmly. In this case, an insertion hole for insertion of a swaging tool may be formed in a portion of the first flow-path-forming plate on an outside of the swaging portion in a radial direction of the through hole. Thus, fixing by swaging can be made easier.

The brazing portion of the pipe member may be arranged so as to close the insertion hole from the inside of the flow path. It is thus possible to reduce leakage of the heat exchange medium in the flow path from the insertion hole while making the fixing by swaging easier.

As can be seen from the foregoing description, the first flow-path-forming plate and the second flow-path-forming plate are brazed to each other to form the flow path, and the pipe member for supplying and discharging is brazed to the inner surface of the first flow-path-forming plate, with the pipe member inserted in the through hole of the first flow-path-forming plate; therefore, it is possible to form the heat exchanger using the flow-path-forming plates each having a sacrificial layer on one surface and reduce the material cost.

### BRIEF DESCRIPTION OF THE DRAWINGS

FIG. 1 is a diagram illustrating a perspective view of a vehicle heat exchanger according to a first embodiment of the present invention as viewed from above.

FIG. 2 is a diagram illustrating a schematic structure of a battery temperature adjustment device.

FIG. 3 is a sectional diagram taken along line III-III in FIG. 1.

FIG. 4 is a diagram illustrating a perspective view of the vicinity of an inlet-side pipe member of the vehicle heat exchanger as viewed from above.

FIG. 5 is a diagram illustrating a plan view of the vicinity of the inlet-side pipe member of the vehicle heat exchanger.

FIG. 6 is a diagram illustrating a sectional view taken along line VI-VI in FIG. 5.

FIG. 7 is a diagram of an exploded view corresponding to line VI-VI in FIG. 5.

FIG. 8 is a diagram corresponding to FIG. 6 before insertion of a swaging tool into an insertion hole.

FIG. 9 is a diagram corresponding to FIG. 6 after insertion of the swaging tool into the insertion hole.

FIG. 10 is a diagram corresponding to FIG. 5 according to a second embodiment of the present invention.

FIG. 11 is a diagram illustrating a sectional view taken along line XI-XI according to the second embodiment, before swaging.

FIG. 12 is a diagram illustrating a sectional view taken along line XI-XI according to the second embodiment, after swaging.

### DETAILED DESCRIPTION

Embodiments of the present invention will be described in detail below with reference to the drawings. The following description of the preferred embodiments is merely illustrative in nature, and is not intended to limit the present invention, its application, or its use.

### First Embodiment

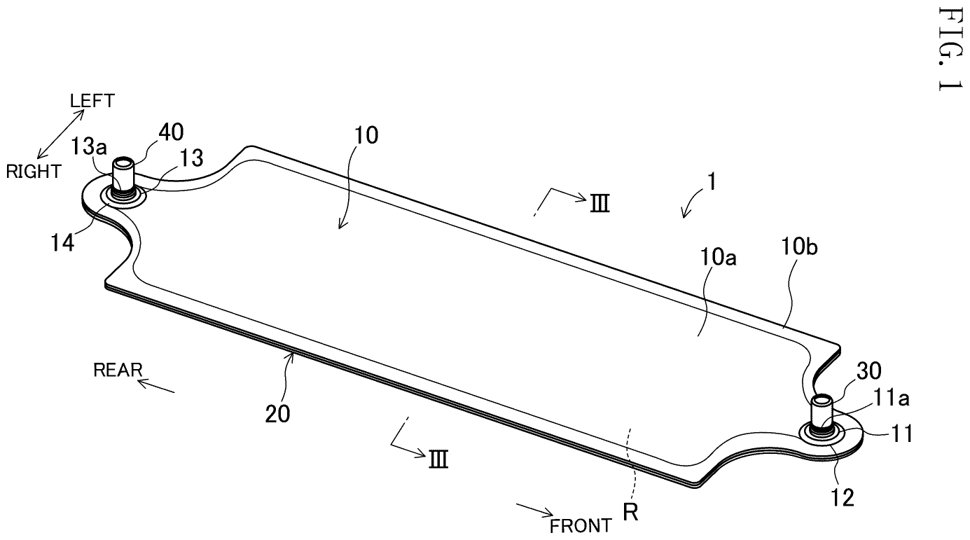

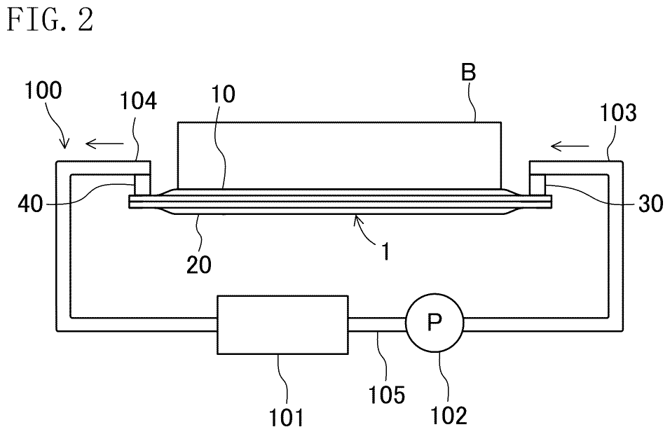

FIG. 1 is a diagram illustrating a perspective view of a vehicle heat exchanger 1 according to a first embodiment of the present invention as viewed from above. FIG. 2 is a diagram illustrating a schematic structure of a battery temperature adjustment device 100 having the vehicle heat exchanger 1. The battery temperature adjustment device 100 is used, for example, for adjusting the temperature of a battery B mounted on a vehicle such as an automobile. The battery B is a battery for supplying electric power to a traction motor (not illustrated) mounted on the automobile, and is configured to have a higher voltage and a larger capacity than general auxiliary batteries. The battery B is disposed, for example, outside the automobile under the floor panel. The bottom surface of the battery B is formed so as to extend in the horizontal direction. The battery B may be configured as a battery unit having a plurality of cells. The type of battery B is not particularly limited, and examples thereof include a lithium-ion battery. The battery B may be disposed in, for example, a vehicle compartment or a luggage compartment.

The automobile may be an electric vehicle which does not include an internal combustion engine, or may be a hybrid vehicle including both an internal combustion engine and a traction motor. The hybrid vehicle may be a plug-in hybrid vehicle. In the case of the electric vehicle and the plug-in hybrid vehicle, the vehicle can be charged from an external charging facility or by regeneration from the traction motor.

The battery temperature adjustment device 100 is configured to adjust the temperature of the battery B using a liquid heat exchange medium. The heat exchange medium may include, for example, coolant liquid, but is not limited thereto, and may be any heat exchange medium having fluidity. The battery temperature adjustment device 100 has, in addition to the vehicle heat exchanger 1, a temperature adjuster 101 that adjusts the temperature of the heat exchange medium, a pump 102 that sends the heat exchange medium, an inlet-side pipe 103, an outlet-side pipe 104, and an intermediate pipe 105. The discharge side of the pump 102 is connected to the inlet side of the vehicle heat exchanger 1 through the inlet-side pipe 103. The outlet side of the vehicle heat exchanger 1 is connected to the temperature adjuster 101 through the outlet-side pipe 104. The temperature adjuster 101 and the suction side of the pump 102 are connected to each other through the intermediate pipe 105. Thus, the vehicle heat exchanger 1, the temperature adjuster 101, and the pump 102 are connected to each other, and a circulation path through which the heat exchange medium can circulate is formed.

The temperature adjuster 101 may be configured as, for example, a heat exchanger that cools the heat exchange medium by exchanging heat between outside air and the heat exchange medium, may be configured as a heater or the like that heats the heat exchange medium, or may be configured as a device or the like that can both cool and heat the heat exchange medium. Although not illustrated, a temperature adjuster for cooling the heat exchange medium and a temperature adjuster for heating the heat exchange medium may be separately provided. To cool the battery B, the heat exchange medium is cooled by the temperature adjuster 101. To heat the battery B, the heat exchange medium is heated by the temperature adjuster 101. The temperature adjuster 101 is controlled by a controller (not illustrated). The controller detects the temperature state of the battery B and the charge-discharge state of the battery B, and controls the temperature adjuster 101 such that the temperature range of the battery B falls within an appropriate range.

The pump 102 is also controlled by the controller. The controller detects the temperature state of the battery B and the charge-discharge state of the battery B, and controls the pump 102 such that the temperature range of the battery B falls within the appropriate range.

The vehicle heat exchanger 1 is used for adjusting the temperature of the battery B by exchanging heat between the battery B and the heat exchange medium such that the temperature range of the battery B falls within the appropriate range. The temperature of the battery B can be adjusted from below if the vehicle heat exchanger 1 is disposed under the battery B, but is not limited thereto. The vehicle heat exchanger 1 may be disposed above the battery B, or may be disposed on a lateral side of the battery B. Multiple vehicle heat exchangers 1 may be disposed so as to vertically sandwich the battery B. The multiple vehicle heat exchangers 1 may be connected in series or in parallel. The term “series” indicates that the multiple vehicle heat exchangers 1 are arranged and connected in the flow direction of the heat exchange medium, and the term “parallel” indicates that the multiple vehicle heat exchangers 1 are arranged and connected such that the heat exchange medium flows into the multiple vehicle heat exchangers 1 at the same time.

In the present embodiment, a case where the vehicle heat exchanger 1 is disposed under the battery B will be described. The vehicle heat exchanger 1 includes an upper flow-path-forming plate (first flow-path-forming plate) 10 disposed on the upper side of the vehicle heat exchanger 1, and a lower flow-path-forming plate (second flow-path-forming plate) 20 disposed on the lower side of the vehicle heat exchanger 1. Since the vehicle heat exchanger 1 is disposed under the battery B, the upper flow-path-forming plate 10 is a contact member in contact with the bottom surface (outer surface) of the battery B, and the lower flow-path-forming plate 20 is a member below the upper flow-path-forming plate 10 and joined to the lower side (opposite side to the battery B) of the upper flow-path-forming plate 10.

The vehicle heat exchanger 1 further includes an inlet-side pipe member (first pipe member) 30 for supplying the heat exchange medium sent from the pump 102 to a flow path R of the vehicle heat exchanger 1, and an outlet-side pipe member (second pipe member) 40 for discharging the heat exchange medium in the flow path R to the outside of the vehicle heat exchanger 1. In this embodiment, the side where the inlet-side pipe member 30 is provided is the front side, and the side where the outlet-side pipe member 40 is provided is the back side. For the sake of convenience of description, the front side is a vehicle front side, and the back side is a vehicle rear side. Further, when viewed while facing toward the vehicle front side, the side on the right is the right side, and the side on the left is the left side. The left-right direction of the vehicle coincides with a width direction. These direction definitions do not limit the direction of the vehicle heat exchanger 1 mounted on the automobile, and the vehicle heat exchanger 1 may be mounted on the vehicle such that the front-rear direction is reversed, or may be mounted such that the left-right direction is oriented in the vehicle front-rear direction.

As illustrated in FIG. 2, the vehicle heat exchanger 1 has a rectangular shape as a whole, which is elongated in the front-rear direction (predetermined direction) along the bottom surface of the battery B, and therefore, both the upper flow-path-forming plate 10 and the lower flow-path-forming plate 20 extend in the front-rear direction. Since the vehicle heat exchanger 1 has the shape elongated in the front-rear direction, the dimension of the vehicle heat exchanger 1 in the front-rear direction is longer than the dimension in the left-right direction. The vehicle heat exchanger 1 may have a shape elongated in the left-right direction, or may have a shape whose dimensions in the front-rear direction and left-right direction are the same. The front side of the vehicle heat exchanger 1 will be referred to as one side in a longitudinal direction, and the rear side of the vehicle heat exchanger 1 will be referred to as the other side in the longitudinal direction.

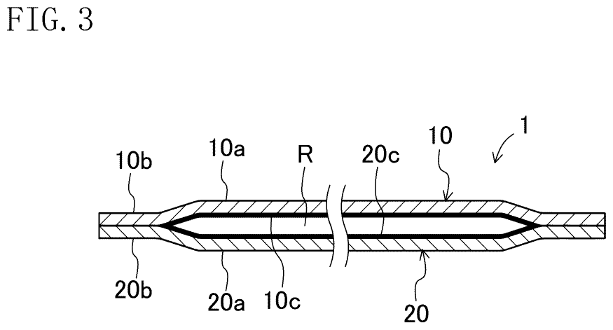

As illustrated in FIG. 3, the flow path R allowing the heat exchange medium to flow is formed between the upper flow-path-forming plate 10 and the lower flow-path-forming plate 20. The flow path R extends in the front-rear direction of the vehicle heat exchanger 1. That is, the upper flow-path-forming plate 10 has an upper bulging portion 10a bulging upward and an upper extending plate portion 10b extending horizontally from a peripheral edge portion of the upper bulging portion 10a toward the outside of the flow path R. The upper bulging portion 10a and the upper extending plate portion 10b are formed of a single aluminum alloy plate. The upper bulging portion 10a and the upper extending plate portion 10b may be molded by a press molding method, for example. The upper flow-path-forming plate 10 is formed from a plate having a sacrificial layer 10c only on a surface (lower surface) to face the lower flow-path-forming plate 20, that is, a plate which is clad with a brazing material (also referred to as a clad material).

The lower flow-path-forming plate 20 has a lower bulging portion 20a bulging downward and a lower extending plate portion 20b extending horizontally from a peripheral edge portion of the lower bulging portion 20a toward the outside of the flow path R. The lower bulging portion 20a and the lower extending plate portion 20b are formed of a single aluminum alloy plate, similarly to the upper flow-path-forming plate 10. The lower flow-path-forming plate 20 is formed of a plate having a sacrificial layer 20c only on a surface (upper surface) to face the upper flow-path-forming plate 10, that is, a plate which is clad with a brazing material. The thicknesses of the upper flow-path-forming plate 10 and the lower flow-path-forming plate may be the same, or may differ from each other.

The upper bulging portion 10a forms an upper wall portion of the flow path R, and is a portion corresponding to the flow path R. The portion corresponding to the flow path R is a portion defining and forming the flow path R. The bottom surface of the battery B contacts the upper surface of the upper bulging portion 10a. On the other hand, the lower bulging portion 20a is located right under the upper bulging portion 10a, and is a portion forming a lower wall portion of the flow path R. The dimension of the flow path R in the up-down direction is set by the bulging amounts of the upper bulging portion 10a and the lower bulging portion 20a, and the dimension of the flow path R in the left-right direction (width direction) is set by the dimensions of the upper bulging portion 10a and the lower bulging portion 20a in the left-right direction. Further, the dimension of the flow path R in the front-rear direction (length direction) is set by the dimensions of the upper bulging portion 10a and the lower bulging portion 20a in the front-rear direction. In this embodiment, the dimension of the flow path R in the up-down direction is set to be shorter than the dimension in the width direction. Thus, the flow path R has a horizontally flat cross section.

The heat exchange medium flowing through the flow path R exchanges heat with the battery B through the upper bulging portion 10a. The upper bulging portion 10a is made of aluminum alloy, which is a material having a high thermal conductivity; therefore, a heat transfer efficiency can be improved.

Each of the upper bulging portion 10a and the lower bulging portion 20a has a front portion, where an intermediate portion in the left-right direction protrudes forward as compared to both the left and right sides. Moreover, each of the upper bulging portion 10a and the lower bulging portion 20a has a rear portion, where an intermediate portion in the left-right direction protrudes rearward as compared to both the left and right sides. Accordingly, the flow path R has a front portion whose intermediate portion in the left-right direction protrudes forward, and a rear portion whose intermediate portion in the left-right direction protrudes rearward.

The upper extending plate portion 10b has an annular shape around the entire circumference of the peripheral edge portion of the upper bulging portion 10a, and is substantially flat. The lower extending plate portion 20b has an annular shape around the entire circumference of the peripheral edge portion of the lower bulging portion 20a, and is substantially flat, similarly to the upper extending plate portion 10b. The lower extending plate portion 20b is disposed right under the upper extending plate portion 10b, and the upper extending plate portion 10b and the lower extending plate portion 20b overlap each other in plan view.

The upper extending plate portion 10b and the lower extending plate portion 20b are portions forming a brazing margin, and the lower surface of the upper extending plate portion 10b and the upper surface of the lower extending plate portion 20b are brazed over the entire circumference. The upper extending plate portion 10b and the lower extending plate portion 20b are brazed to each other, thereby ensuring the sealability between the upper extending plate portion 10b and the lower extending plate portion 20b.

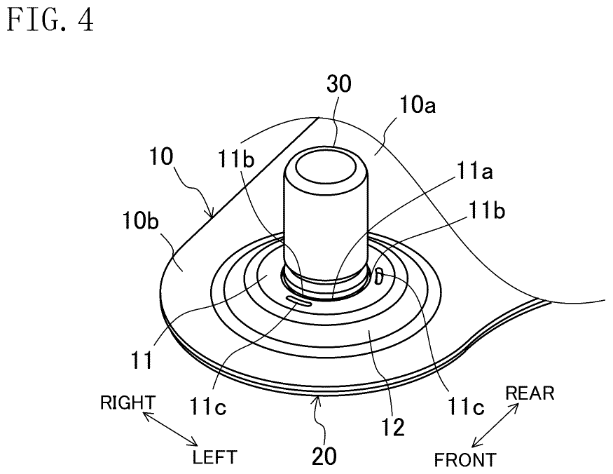

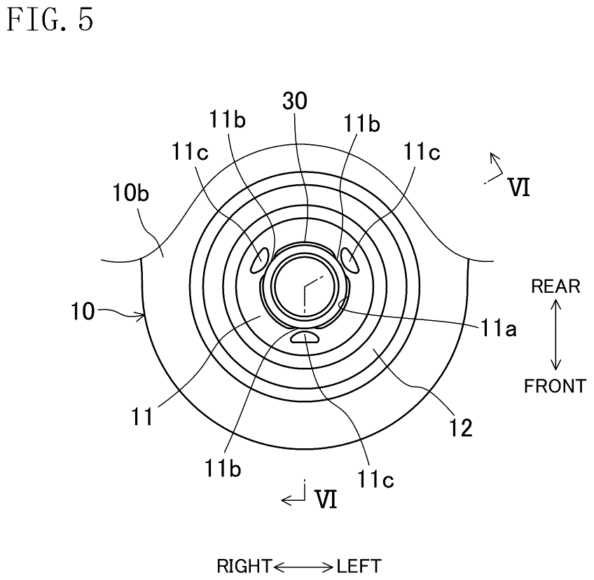

As illustrated in FIGS. 4 to 7, the front portion of the upper bulging portion 10a of the upper flow-path-forming plate 10 has a circular front flat portion 11 extending horizontally. The front flat portion 11 is one step higher than the front portion of the upper bulging portion 10a. Accordingly, a front inclined portion 12 is formed at a peripheral edge portion of the front flat portion 11, inclined downward in the radially outward direction.

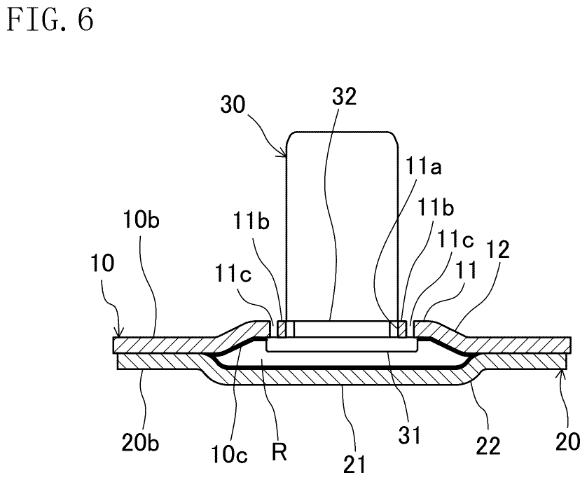

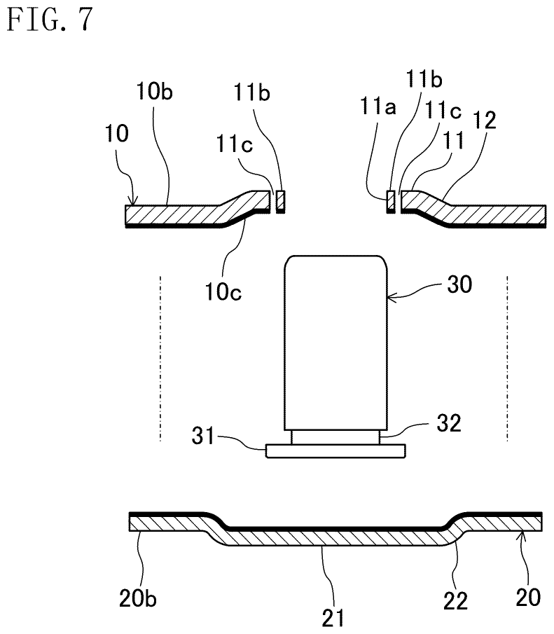

As illustrated in FIGS. 6 and 7, the front portion of the lower bulging portion 20a of the lower flow-path-forming plate 20 has a circular front flat portion 21 extending horizontally. The front flat portion 21 is one step lower than the front portion of the lower bulging portion 20a. Accordingly, a front inclined portion 22 is formed at a peripheral edge portion of the front flat portion 21, inclined upward in the radially outward direction. The front flat portion 21 of the lower flow-path-forming plate 20 and the front flat portion 11 of the upper flow-path-forming plate 10 are disposed so as to overlap each other in plan view.

The front flat portion 11 has a front through hole (first through hole) 11a into which a base end portion of the inlet-side pipe member 30 is inserted. The front through hole 11a has a circular shape, and penetrates the front flat portion 11 in the thickness direction (up-down direction). Since the front flat portion 11 has a planar shape, the lower surface (inner surface) of the front flat portion 11 also has a planar shape, and the surface around the front through hole 11a also has a planar shape.

The inlet-side pipe member 30 is formed of a cylindrical member made of aluminum alloy, and is attached to the upper flow-path-forming plate 10 with its axis extending in the up-down direction. A brazing portion 31 (first brazing portion) is provided at a portion of the base end portion of the inlet-side pipe member 30 located inside the flow path R, and is brazed to the inner surface of the upper flow-path-forming plate 10, specifically the inner surface of the front flat portion 11. The brazing portion 31 is an annular projection projecting radially outward from the outer surface of the inlet-side pipe member 30 and extending continuously in the circumferential direction. In this embodiment, the brazing portion 31 is provided at the base end of the inlet-side pipe member 30, but is not limited thereto: the brazing portion 31 may be provided at a location away from the base end of the inlet-side pipe member 30 toward the tip end side.

An annular groove 32 extending continuously in the circumferential direction is also formed in the outer surface of the inlet-side pipe member 30. The groove 32 is located closer to the tip end side of the inlet-side pipe member 30 than the brazing portion 31, and is adjacent to the brazing portion 31. In a state in which the brazing portion 31 is brought into contact with the inner surface of the front flat portion 11, the groove 32 and the inner surface of the front through hole 11a are positioned at the same height.

Multiple swaging portions 11b for temporarily fixing the inlet-side pipe member 30 to the upper flow-path-forming plate 10 are provided at the front flat portion 11 of the upper flow-path-forming plate 10. In this embodiment, three swaging portions 11b are disposed at intervals in the circumferential direction of the front through hole 11a. The swaging portions 11b are formed of part of a peripheral edge portion of the front through hole 11a; therefore, when the brazing portion 31 is brought into contact with the inner surface of the front flat portion 11, the swaging portion 11b is brought to the same height as the groove 32 of the inlet-side pipe member 30.

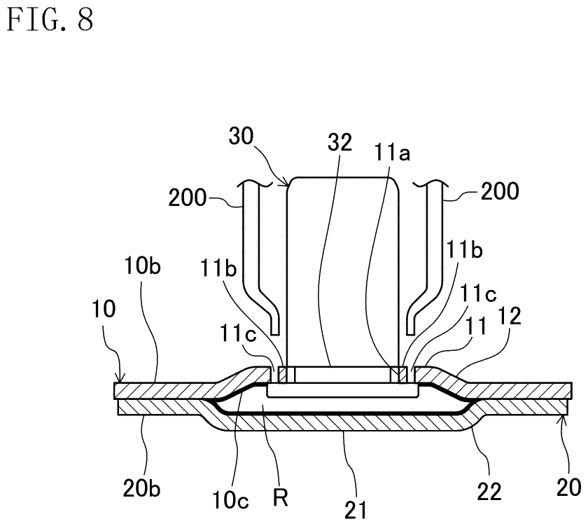

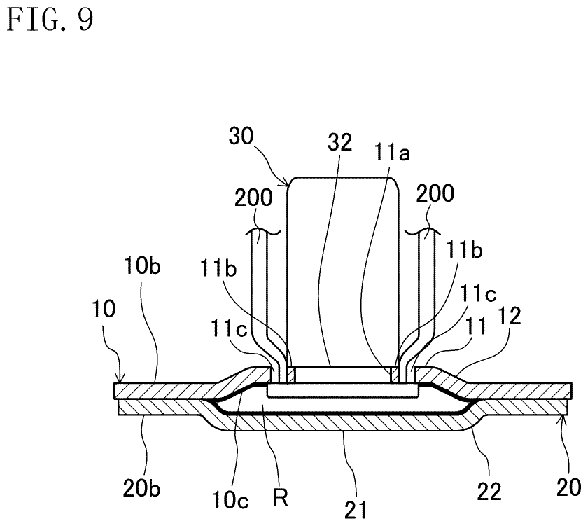

An insertion hole 11c for insertion of a swaging tool 200 (illustrated in FIGS. 8 and 9) is formed in a portion of the upper flow-path-forming plate 10 on an outside of the swaging portions 11b in the radial direction of the front through hole 11a. The number of insertion holes 11c is the same as the number of swaging portions 11b, and the insertion holes 11c and the swaging portions 11b are arranged at the same positions in the circumferential direction of the front through hole 11a.

As illustrated in FIG. 9, the swaging tool 200 is inserted into each insertion hole 11c, and a force is applied inward in the radial direction of the front through hole 11a, which causes elastic deformation of the swaging portion 11b inward in the radial direction of the front through hole 11a. At this moment, since each of the swaging portions 11b and the groove 32 of the inlet-side pipe member 30 are positioned at the same height, the swaging portions 11b enter the groove 32 and are swaged and fixed to the inlet-side pipe member 30. The inlet-side pipe member 30 is temporarily fixed to the upper flow-path-forming plate 10 before brazing. That is, each swaging portion 11b is a temporary fixing portion for temporarily fixing the inlet-side pipe member 30 to the upper flow-path-forming plate 10.

The projection amount of the brazing portion 31 of the inlet-side pipe member 30 in the radial direction is set such that the brazing portion 31 is located right under the insertion holes 11c and can close the insertion holes 11c. That is, in the state in which the inlet-side pipe member 30 is temporarily fixed to the upper flow-path-forming plate 10, the brazing portion 31 closes the insertion holes 11c from the inside of the flow path R.

The number of insertion holes 11c and the number of swaging portions 11b are not limited to three, and may be set to any number including two or less or four or more. One insertion hole 11c and one swaging portion 11b may be provided. The swaging portions 11b may be brought into contact with the outer surface of the inlet-side pipe member 30, without forming the groove 32 in the inlet-side pipe member 30.

As illustrated in FIG. 1, the rear portion of the upper bulging portion 10a of the upper flow-path-forming plate 10 has a rear flat portion 13 and a rear inclined portion 14, similar to the front flat portion 11. Although not illustrated, a rear portion of the lower bulging portion 20a of the lower flow-path-forming plate 20 has a rear flat portion similar to the front flat portion 21 and a rear inclined portion.

The rear flat portion 13 has a rear through hole (second through hole) 13a into which a base end portion of the outlet-side pipe member 40 is inserted. The rear through hole 13a is similar to the front through hole 11a.

The outlet-side pipe member 40 is configured similarly to the inlet-side pipe member 30, and has a brazing portion (second brazing portion) and a groove, although not illustrated. Although not illustrated, multiple swaging portions for temporarily fixing the outlet-side pipe member 40 to the upper flow-path-forming plate 10, and insertion holes for insertion of a swaging tool, are provided at the rear flat portion 13 of the upper flow-path-forming plate 10, similarly to the front side.

The inlet-side pipe member 30 and the outlet-side pipe member 40 can be brazed simultaneously with the brazing between the upper flow-path-forming plate 10 and the lower flow-path-forming plate 20. Specifically, the inlet-side pipe member 30 and the outlet-side pipe member 40 are temporarily fixed to the upper flow-path-forming plate 10; thereafter, the upper flow-path-forming plate 10 is held in an overlapped state with the lower flow-path-forming plate 20. In this state, the upper extending plate portion 10b and the lower extending plate portion 20b overlap each other in the up-down direction.

Thereafter, the upper flow-path-forming plate 10, to which the inlet-side pipe member and the outlet-side pipe member 40 are temporarily fixed, and the lower flow-path-forming plate 20 are carried into a brazing furnace, heated to the melting temperature of a brazing material, and carried out of the furnace. The vehicle heat exchanger 1 is obtained when the brazing material is solidified, which causes the brazing of the inlet-side pipe member 30 and the outlet-side pipe member 40 to the upper flow-path-forming plate 10, and the brazing between the upper extending plate portion 10b and the lower extending plate portion 20b. The upper flow-path-forming plate 10 and the lower flow-path-forming plate 20 may be brazed to each other after brazing the inlet-side pipe member 30 and the outlet-side pipe member 40 to the upper flow-path-forming plate 10.

### Effects and Advantages of Embodiment

As can be seen from the foregoing description, according to the present embodiment, to braze the upper flow-path-forming plate 10 and the lower flow-path-forming plate 20 to each other, the sacrificial layers 10c, 20c are provided on the inner surface of the upper flow-path-forming plate 10 and the inner surface of the lower flow-path-forming plate 20, respectively, which enables the brazing between the upper flow-path-forming plate 10 and the lower flow-path-forming plate 20.

In brazing the inlet-side pipe member 30 to the upper flow-path-forming plate 10, the brazing portion 31 of the inlet-side pipe member 30 is located inside the flow path R and is brazed to the inner surface of the upper flow-path-forming plate 10; therefore, it is not necessary to provide a sacrificial layer on the outer surface of the upper flow-path-forming plate 10. Thus, it is only necessary to prepare the upper flow-path-forming plate 10 and the lower flow-path-forming plate 20 each having a sacrificial layer on one surface, and a material cost is lower than that of a plate having sacrificial layers on both surfaces. The same applies to brazing of the outlet-side pipe member 40.

Since the inlet-side pipe member 30 and the outlet-side pipe member 40 can be temporarily fixed to the upper flow-path-forming plate 10 before brazing the inlet-side pipe member 30 and the outlet-side pipe member 40, it is possible to prevent the inlet-side pipe member 30 and the outlet-side pipe member 40 from dropping or becoming misaligned before brazing. Thus, the inlet-side pipe member 30 and the outlet-side pipe member 40 can be brazed to predetermined positions of the upper flow-path-forming plate 10 with accuracy.

### Second Embodiment

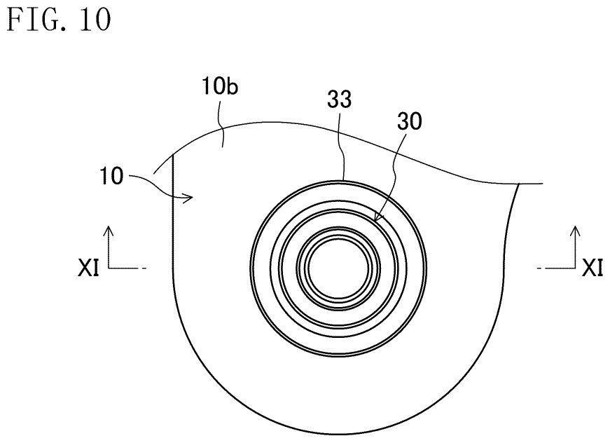

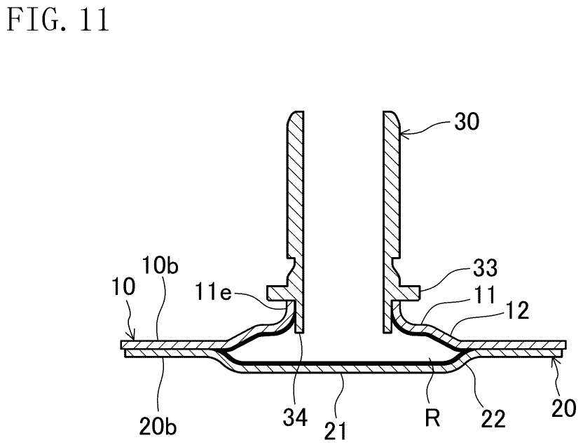

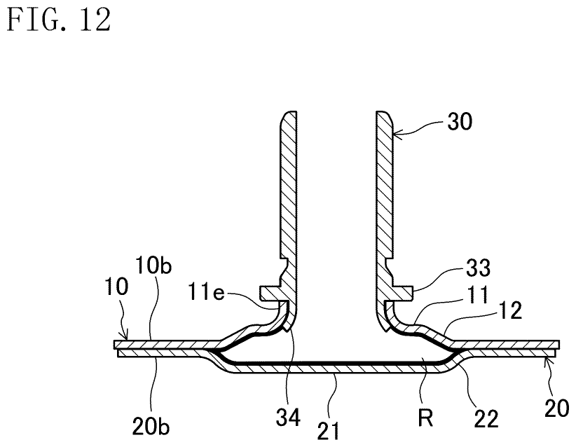

FIGS. 10 to 12 relate to a second embodiment of the present invention. In the second embodiment, a temporary fixing structure of an inlet-side pipe member 30 and an outlet-side pipe member 40 to an upper flow-path-forming plate 10 differs from that of the first embodiment. In the following description, the same parts as those in the first embodiment are denoted by the same reference numerals, and the description thereof will be omitted. Different parts will be described in detail.

The inlet-side pipe member 30 of the second embodiment has a flange portion 33 at a portion outside the flow path R. Further, an annular portion 11e formed by burring, which is an upwardly projected portion, is provided around the front through hole 11a in the front flat portion 11. The base end portion of the inlet-side pipe member 30 is inserted into the portion 11e formed by burring. With the inlet-side pipe member 30 inserted in the portion 11e formed by burring, the upper end portion of the portion 11e formed by burring is in contact with the lower surface of the flange portion 33, thereby achieving the positioning of the inlet-side pipe member 30.

Using a tool not shown, the diameter of the base end portion 34 of the inlet-side pipe member 30 is expanded from inside the pipe member 30, thereby making it possible to temporarily fix the inlet-side pipe member 30 to the upper flow-path-forming plate 10. The inlet-side pipe member 30 in this state is carried into a brazing furnace, so that a portion of the base end portion of the inlet-side pipe member 30 located inside the flow path R is brazed to the inner surface of the portion 11e formed by burring of the upper flow-path-forming plate 10. That is, in the second embodiment, the outer surface of the base end portion of the inlet-side pipe member 30 is the brazing portion. Thus, the second embodiment can also provide effects and advantages similar to those of the first embodiment, and the material cost can be reduced.

The above-described embodiments are merely examples in all respects and should not be construed in a limited manner. Further, all modifications and changes belonging to the equivalent scope of the claims are included in the scope of the present invention. For example, the first embodiment and the second embodiment can be applied to a single vehicle heat exchanger 1. The projection direction of the inlet-side pipe member 30 and the outlet-side pipe member 40 is not limited to the upward direction, and may be the downward direction. In this case, the vehicle heat exchanger 1 can be used in an upside-down orientation.

As can be seen from the foregoing description, the vehicle heat exchanger according to the present invention can be used, for example, to adjust the temperature of a battery mounted on a vehicle.

What is claimed is:

1. A vehicle heat exchanger for a temperature adjustment of a battery that supplies electric power to a traction motor mounted on a vehicle, wherein
a first flow-path-forming plate made of a metal and a second flow-path-forming plate made of a metal are brazed to each other, the first flow-path-forming plate being in contact with an outer surface of the battery, the second flow-path-forming plate being arranged on an opposite side of the first flow-path-forming plate to the battery,
a flow path that allows a liquid heat exchange medium to flow is provided between the first flow-path-forming plate and the second flow-path-forming plate,
the first flow-path-forming plate has a through hole for insertion of a base end portion of a pipe member for supplying and discharging the heat exchange medium, and
a brazing portion is provided at a portion of the base end portion of the pipe member located inside the flow path, the brazing portion being brazed to an inner surface of the first flow-path-forming plate.

2. The vehicle heat exchanger of claim 1, wherein
the first flow-path-forming plate has a flat portion at a portion corresponding to the flow path,
the through hole penetrates the flat portion, and
the brazing portion is brazed to an inner surface of the flat portion.

3. The vehicle heat exchanger of claim 1, wherein
the first flow-path-forming plate is formed of a plate having a sacrificial layer only on a surface facing the second flow-path-forming plate.

4. The vehicle heat exchanger of claim 1, wherein
the second flow-path-forming plate is formed of a plate having a sacrificial layer only on a surface facing the first flow-path-forming plate.

5. The vehicle heat exchanger of claim 1, wherein
the first flow-path-forming plate is arranged so as to be in contact with a bottom surface of the battery, and has a long shape in a predetermined direction along the bottom surface, and
the second flow-path-forming plate is arranged under the first flow-path-forming plate, and extends in the predetermined direction.

6. The vehicle heat exchanger of claim 5, wherein
the pipe member includes a first pipe member to supply the heat exchange medium to the flow path and a second pipe member to discharge the heat exchange medium from the flow path, the first pipe member being provided on one side in a longitudinal direction of the first flow-path-forming plate, the second pipe member being provided on the other side in the longitudinal direction of the first flow-path-forming plate,
a first through hole for insertion of a base end portion of the first pipe member is formed on the one side in the longitudinal direction of the first flow-path-forming plate,
a second through hole for insertion of a base end portion of the second pipe member is formed on the other side in the longitudinal direction of the first flow-path-forming plate,
a first brazing portion is provided at a portion of the base end portion of the first pipe member located inside the flow path, the first brazing portion being brazed to the inner surface of the first flow-path-forming plate, and
a second brazing portion is provided at a portion of the base end portion of the second pipe member located inside the flow path, the second brazing portion being brazed to the inner surface of the first flow-path-forming plate.

7. The vehicle heat exchanger of claim 1, wherein
the brazing portion is formed of a projection projecting radially outward from an outer surface of the pipe member and extending in a circumferential direction.

8. The vehicle heat exchanger of claim 1, wherein
the first flow-path-forming plate has a temporary fixing portion to fix temporarily the pipe member to the first flow-path-forming plate.

9. The vehicle heat exchanger of claim 8, wherein
the temporary fixing portion is formed of a swaging portion to be swaged and fixed to the pipe member.

10. The vehicle heat exchanger of claim 9, wherein
an insertion hole for insertion of a swaging tool is formed in a portion of the first flow-path-forming plate on an outside of the swaging portion in a radial direction of the through hole.

11. The vehicle heat exchanger of claim 10, wherein
the brazing portion is arranged so as to close the insertion hole from an inside of the flow path.
